(19) United States
(12) Patent Application Publication
(10) Pub. No.: US 2025/0164370 A1
(43) Pub. Date: May 22, 2025

(54) FILM EVALUATION SYSTEM AND EVALUATION METHOD THEREOF

(71) Applicant: INDUSTRIAL TECHNOLOGY RESEARCH INSTITUTE, Hsinchu (TW)

(72) Inventors: Meng-Shun HUANG, Hsinchu City (TW); Ting-Ting CHANG, Taichung City (TW); Wu-Yang SEAN, Hsinchu City (TW); Yi-Hsien CHIANG, Taichung City (TW); Jen-Chieh WU, Taipei City (TW)

(73) Assignee: INDUSTRIAL TECHNOLOGY RESEARCH INSTITUTE, Hsinchu (TW)

(21) Appl. No.: 18/900,157

(22) Filed: Sep. 27, 2024

Related U.S. Application Data
(60) Provisional application No. 63/586,199, filed on Sep. 28, 2023.

(51) Int. Cl. G01N 11/04; G01N 13/00

(52) U.S. Cl. CPC G01N 11/04; G01N 13/00; G01N 2013/003

(57) ABSTRACT

Film evaluation system and evaluation method thereof are provided. The film evaluation system includes a measurement unit, an observation unit, an adaptive algorithm unit, an estimation unit, and a health state calculation unit. The measurement unit obtains an initial state parameter set corresponding to a film. The observation unit is connected to the measurement unit and obtains a flux observation value according to the initial state parameter set. The adaptive algorithm unit is connected to the observation unit and obtains a flux prediction value according to the initial state parameter set. The estimation unit is connected to the adaptive algorithm unit and obtains a diffusion rate and a flow resistance by comparing the flux observation value and the flux prediction value. The health state calculation unit is connected to the estimation unit and obtains a health state of the film according to the diffusion rate and the flow resistance.

### CROSS REFERENCE TO RELATED APPLICATIONS

This application claims the benefit of U.S. Provisional Application No. 63/586,199, filed on Sep. 28, 2023, which is hereby incorporated by reference herein in its entirety.

### TECHNICAL FIELD

The present disclosure relates to a film evaluation system and an evaluation method thereof, in particular, it relates to a film evaluation system and a film evaluation method that can obtain the health state of the film, and at the same time reduce specific energy consumption and extend the life of the film through optimized operating pressure calculations.

### BACKGROUND

Since water resources are closely related to life, issues such as water resources development, water resources treatment, and water resource recycling have become one of the sustainable development goals of various countries. For example, water shortages may be caused by seasonal water shortages, and they are often addressed by using desalination and fostering regenerative aquaculture.

In general, membranes (films) may be used for water resource treatment. However, it may be difficult to adjust film-related parameters without evaluating the health state of the film. Even with existing film evaluation systems, it still may not be possible to accurately evaluate the health state of the film. In addition, the energy consumption of film treatment using high pressure may account for more than half of the total energy consumption of a water treatment system. Appropriate operating pressure and appropriate film-related parameters will significantly affect the energy consumption of the film treatment. Therefore, how to obtain optimized operating pressure and film-related parameters has become more important.

Therefore, although some of the existing medium and large-scale film evaluation systems and evaluation methods thereof have gradually met their intended purposes, they may not be able to fully meet the requirements in terms of achieving the energy conservation, the target water production volume (contracted water production volume), and extended life of film. Therefore, there is still a need to develop improved film evaluation systems and evaluation methods thereof.

### SUMMARY

In some embodiments of the present disclosure, a film evaluation system is provided. The film evaluation system includes a measurement unit, an observation unit, an adaptive algorithm unit, an estimation unit, and a health state calculation unit. The measurement unit obtains an initial state parameter set corresponding to a film. The observation unit is connected to the measurement unit, wherein the observation unit obtains a flux observation value according to the initial state parameter set. Also, an optimized operating pressure, a water recovery rate, and a specific energy consumption are calculated accordingly. The adaptive algorithm unit is connected to the observation unit, wherein the adaptive algorithm unit obtains a flux prediction value according to the initial state parameter set. The estimation unit is connected to the adaptive algorithm unit, wherein the estimation unit obtains a diffusion rate and a flow resistance by comparing the flux observation value and the flux prediction value. The health state calculation unit is connected to the estimation unit, wherein the health state calculation unit obtains a health state of the film according to the diffusion rate and the flow resistance.

In some embodiments of the present disclosure, a film evaluation method is provided. The film evaluation method includes obtaining an initial state parameter set corresponding to a film, for example, an initial pollutant concentration value. A flux observation value is obtained according to the initial pollutant concentration value. A flux prediction value is obtained according to the initial pollutant concentration value. A diffusion rate and a flow resistance are obtained by comparing the flux observation value with the flux prediction value. A healthy state of the film is obtained according to the diffusion rate and the flow resistance.

The film evaluation system and evaluation method thereof of the present disclosure may be applied in various types of film apparatus. In order to make the features and advantages of some embodiments of the present disclosure more understand, some embodiments of the present disclosure are listed below in conjunction with the accompanying drawings, and are described in detail as follows.

### BRIEF DESCRIPTION OF THE DRAWINGS

The present disclosure can be more fully understood from the following detailed description when read in conjunction with the accompanying drawings. It should be noted that, according to the standard practice in the industry, the various features are not drawn to scale. In fact, the dimensions of the various features may be arbitrarily increased or reduced for clarity.

FIG. 1 shows a schematic system diagram of a film evaluation system according to some embodiments of the present disclosure.

FIG. 2 shows a schematic flowchart of a film evaluation method according to some embodiments of the present disclosure.

FIG. 3 shows a schematic diagram of the diffusion rate, the flow resistance, and the health state versus the time according to some embodiments of the present disclosure.

FIG. 4 shows a schematic diagram of the first parameter versus the time according to an example of the present disclosure.

FIG. 5 shows a schematic diagram of the second parameter versus the time according to an example of the present disclosure.

FIG. 6 shows a schematic diagram of the flux versus the time according to an example of the present disclosure.

FIG. 7 shows a schematic diagram of the flux and the recovery rate versus the time according to a comparative example of the present disclosure.

FIG. 8 shows a schematic diagram of the specific energy consumption versus the time according to an example of the present disclosure.

FIG. 9 shows a schematic diagram of the specific energy consumption and the pressure versus the time according to a comparative example of the present disclosure.

### DETAILED DESCRIPTION

The film evaluation systems and the evaluation methods thereof of various embodiments of the present disclosure will be described in detail below. It should be understood that the following description provides many different embodiments for implementing various aspects of some embodiments of the present disclosure. The specific elements and arrangements described below are merely to clearly describe some embodiments of the present disclosure. Certainly, these are only used as examples rather than limitations of the present disclosure. Furthermore, similar or corresponding reference numerals may be used in different embodiments to designate similar or corresponding elements in order to clearly describe the present disclosure. However, the use of these similar or corresponding reference numerals is only for the purpose of simply and clearly description of some embodiments of the present disclosure, and does not imply any correlation between the different embodiments or structures discussed.

It should be understood that ordinal numbers, for example, “first”, “second”, and the like used in the description and claims are used to modify elements and are not intended to imply and represent the element(s) have any previous ordinal numbers, and do not represent the order of a certain element and another element, or the order of the manufacturing method, and the use of these ordinal numbers is only used to clearly distinguished an element with a certain name and another element with the same name. The claims and the specification may not use the same terms, for example, a first element in the specification may be a second element in the claim.

In some embodiments of the present disclosure, terms related to bonding and connection, for example, “connect”, “interconnect”, “bond”, and the like, unless otherwise defined, may refer to two structures in direct contact, or may also refer to two structures not in direct contact, that is there is another structure disposed between the two structures. Moreover, the terms related to bonding and connection can also include embodiments in which both structures are movable, or both structures are fixed. Furthermore, the terms “electrically connected” or “electrically coupled” include any direct and indirect means of electrical connection.

Herein, the terms “approximately”, “about”, and “substantially” generally mean within 10%, within 5%, within 3%, within 2%, within 1%, or within 0.5% of a given value or range. The given value is an approximate value, that is, “approximately”, “about”, and “substantially” can still be implied without the specific description of “approximately”, “about”, and “substantially”. The phrase “a range between a first value and a second value” or “a first value-a second value” means that the range includes the first value, the second value, and other values in between. Furthermore, any two values or directions used for comparison may have certain tolerance. If the first value is equal to the second value, it implies that there may be a tolerance within about 10%, within 5%, within 3%, within 2%, within 1%, or within 0.5% between the first value and the second value.

Certain terms may be used throughout the specification and claims in the present disclosure to refer to specific elements. The present disclosure does not intend to distinguish between elements that have the same function but with different terms. In the following description and claims, terms, for example, “including”, “comprising”, and “having” are open-ended words, so they should be interpreted as meaning “including but not limited to . . . ”. Therefore, when the terms “including”, “comprising”, and/or “having” is used in the description of the present disclosure, it designates the presence of corresponding features, regions, steps, operations, and/or elements, but does not exclude the presence of one or more corresponding features, regions, steps, operations, and/or elements.

It should be understood that, in the following embodiments, features in several different embodiments may be replaced, recombined, and bonded to complete other embodiments without departing from the spirit of the present disclosure. The features of the various embodiments can be used in any combination as long as they do not violate the spirit of the present disclosure or conflict with each other.

Unless otherwise defined, all terms (including technical and scientific terms) used herein have the same meaning as commonly understood by a person of ordinary skills in the art. It is understood that these terms, for example, those defined in commonly used dictionaries, should be interpreted as having meanings consistent with the relevant art and the background or context of the present disclosure, and should not be interpreted in an idealized or overly formal manner, unless otherwise defined in the embodiments of the present disclosure.

In some embodiments, the film evaluation system and evaluation method thereof of the present disclosure may be applied to sewage treatment, seawater desalination, water quality pretreatment in water plants, metal recovery in wastewater, other suitable applications or a combination thereof, but the present disclosure is not limited thereto.

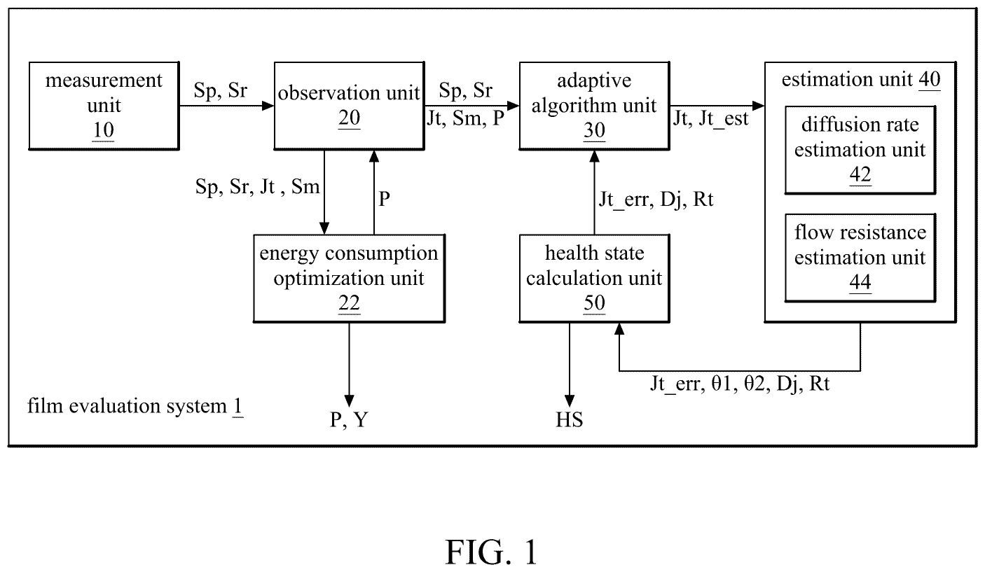

Referring to FIG. 1, it shows a schematic system diagram of a film evaluation system 1 according to some embodiments of the present disclosure. In some embodiments, the film that may be evaluated may include microfiltration (MF) film, ultrafiltration (UF) film, nanofiltration (NF) film, reverse osmosis (RO) film, forward osmosis (FO) film, membrane distillation (MD) film, ceramic film, other suitable films, or a combination thereof, but the present disclosure is not limited thereto. In some embodiments, the film may include polypropylene (PP), polyvinylidene fluoride (PVDF), polytetrafluoroethylene (PTFE), polysulfone (PSF), polyethersulfone (PES), cellulose acetate (CA), other suitable materials, or a combinations thereof, but the present disclosure is not limited thereto.

In some embodiments, the film evaluation system 1 may include a measurement unit 10, an observation unit 20, an energy consumption optimization unit 22, an adaptive algorithm unit 30, an estimation unit 40, and a health state calculation unit 50.

As shown in FIG. 1, in some embodiments, the measurement unit 10 may obtain initial state parameter sets (for example, initial values) Sp and Sr corresponding to before and after film treatment (for example, filtration). In some embodiments, the initial state parameter sets Sp and Sr of the film may include permeate values Sp related to the permeate that passes through the film, and retentate values Sr related to the retentate that does not pass through the film.

In some embodiments, the initial state parameter sets Sp and Sr of the film may include water quality, pressure, water flow, temperature, other parameters, or a combinations thereof respectively corresponding to the permeate and retentate, but the present disclosure is not limited thereto. In some embodiments, the water quality may include biochemical oxygen demand (BOD), chemical oxygen demand (COD), ammonia content, nitrogen content, chlorine content, total dissolved solids (TDS), conductivity, resistivity, alkalinity, hardness, pH value, turbidity, micro-organism, other parameters, or a combination thereof, but the present disclosure is not limited thereto. In some embodiments, the measurement unit 10 may include a water quality meter, a pressure gauge, a water flow meter, a thermometer, other suitable measurement devices, or a combination thereof, but the present disclosure is not limited thereto.

In some embodiments, each of the observation unit 20, the energy consumption optimization unit 22, the adaptive algorithm unit 30, the estimation unit 40, and the health state calculation unit 50 may include processing and storage components, such as processing unit, computer-readable medium, memory, and the like, are used to execute computer programs to realize their corresponding functions. The processing unit may include a central processing unit (CPU), a multi-core CPU, a graphics processing unit (GPU), and the like, but the present disclosure is not limited thereto. The computer-readable medium may include compact disc read-only memory (CD-ROM), hard disk driver, erasable programable read-only memory (EPROM), electrically erasable programable read-only memory (EEPROM), and the like, but the present disclosure is not limited thereto. The memory may include dynamic random access memory (DRAM), static random access memory (SRAM), flash memory, and the like, but the present disclosure is not limited thereto.

The term “computer program” as used herein refers to an application program stored in the computer-readable medium that may be read into the memory for processing by the processing unit. In some embodiments, the application programs may be coded in one or more programming languages. The programming languages include object-oriented programming languages, such as Java, Smalltalk, C++, python, or similar programming languages. The programming languages may also include traditional programming languages, such as the C programming language or similar programming languages. In some embodiments, the film evaluation system 1 may be implemented using a field programmable gate array (FPGA).

As shown in FIG. 1, in some embodiments, the observation unit 20 may be connected to the measurement unit 10, and the observation unit 20 may obtain a flux observation value Jt, a film value Sm, and an operating pressure P according to the initial state parameter sets Sp and Sr before and after the film treatment. In some embodiments, since the flux observation value Jt and the film value Sm are not easily obtained by directly using a measuring device for measurement, the flux observation value Jt and the film value Sm are obtained from theoretical calculations based on the initial state parameter sets Sp and Sr. Wherein, the film value Sm may be the film pollutant concentration value. However, since they are only theoretically calculated, the flux observation value Jt and the film value Sm may still be regarded as values obtained directly through measurement.

As shown in FIG. 1, in some embodiments, the energy consumption optimization unit 22 may be connected to the observation unit 20, and the energy consumption optimization unit 22 may obtain the operating pressure P, for example, a feed pressure, according to the flux observation value Jt. In some embodiments, the energy consumption optimization unit 22 may transmit the initial state parameter sets Sp and Sr of the film, the flux observation value Jt, and the film value Sm to the energy consumption optimization unit 22, and the energy consumption optimization unit 22 may obtain the operating pressure P and the water recovery rate Y based on the initial state parameter sets Sp, Sr before and after film treatment, the flux observation value Jt, and the film value Sm. In some embodiments, since the operating pressure P and the water recovery rate Y may be obtained through theoretical calculation based on the current initial state parameter sets Sp, Sr, the flux observation value Jt, and the film value Sm, the adaptive algorithm unit 30 may not be used to repeatedly update and correct the operating pressure P and the water recovery rate Y. In some embodiments, the energy consumption optimization unit 22 may transmit the operating pressure P to the observation unit 20, the adaptive algorithm unit 30, and the estimation unit 40. Therefore, the estimation unit 40 may obtain the diffusion rate Dj and the flow resistance Rt according to the flux observation value Jt, the flux prediction value Jt_est, and the operating pressure P.

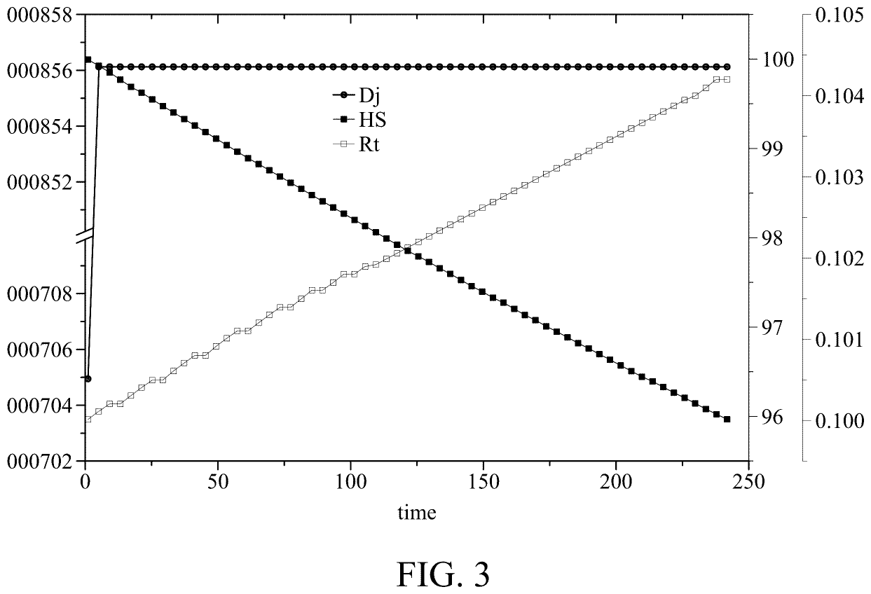

As shown in FIG. 3, in some embodiments, the energy consumption optimization unit 22 may further transmit the operating pressure P to other units or may directly control the pressure valve. For example, since the energy consumption optimization unit 22 of the present disclosure may obtain the current operating pressure P based on the initial state parameter sets Sp and Sr before and after the film treatment, the flux observation value Jt, and the film value Sm, the energy consumption optimization unit 22 may perform pressure control according to the current operating pressure P.

In detail, when the operating pressure P is too large, the life of the film will be reduced. When the operating pressure P is too small, it is difficult to achieve the target permeate flow rate, which is the contracted water production volume. Therefore, the energy consumption optimization unit 22 of the present disclosure may obtain the immediate optimized operating pressure P and adjust the feed pressure into the optimized pressure, thereby reducing the energy required during the film treatment and reducing the specific energy consumption (SEC). In other words, the optimized operating pressure P provided by the energy consumption optimization unit 22 may achieve the effects of saving energy, maintaining the target permeate flow rate, and/or extending the life of the film. Therefore, the energy consumption optimization unit 22 may obtain the optimized specific energy consumption based on the initial state parameter sets Sp and Sr, the flux observation value Jt, and the film value Sm before and after the film treatment. Accordingly, the observation unit 20 connected to the energy consumption optimization unit 22 may obtain the optimized operating pressure P, the water recovery rate Y, and the specific energy consumption through calculations by the energy consumption optimization unit 22.

As shown in FIG. 1, in some embodiments, the adaptive algorithm unit 30 may be connected to the observation unit 20, and the adaptive algorithm unit 30 may obtain the flux prediction value Jt_est according to the initial state parameter sets Sp and Sr of the film. In some embodiments, the adaptive algorithm unit 30 may store a fouling model corresponding to the film, and the adaptive algorithm unit 30 may obtain the flux prediction value Jt_est based on the fouling model. In some embodiments, the adaptive algorithm unit 30 may use an adaptive control algorithm (ACA) to perform calculations. In some embodiments, the adaptive algorithm unit 30 may not use machine learning algorithms.

As shown in FIG. 1, in some embodiments, the estimation unit 40 may be connected to the adaptive algorithm unit 30, and the estimation unit 40 may obtain the diffusion rate Dj and the flow resistance Rt by comparing the flux observation value Jt and the flux prediction value Jt_est. In some embodiments, the estimation unit 40 may obtain the flux error value Jt_err by comparing the flux observation value Jt and the flux prediction value Jt_est, where the difference between the flux observation value Jt and the flux prediction value Jt_est may be he flux error value Jt_err. In some embodiments, the estimation unit 40 may obtain the diffusion rate Dj and the flow resistance Rt according to the flux error value Jt_err.

As shown in FIG. 1, in some embodiments, the estimation unit 40 may store the control differential equation, and the estimation unit 40 obtains the first parameter θ1 and the second parameter θ2 based on the control differential equation and according to the flux error value Jt_err. Wherein, the first parameter θ1 may be related to the diffusion rate Dj, and the second parameter θ2 may be related to the flow resistance Rt. As shown in FIG. 1, in some embodiments, the estimation unit 40 may include a diffusion rate estimation unit 42 and a flow resistance estimation unit 44. In some embodiments, the diffusion rate estimation unit 42 may obtain (extract) the diffusion rate Dj according to the first parameter θ1. In some embodiments, the flow resistance estimation unit 44 may obtain (extract) the flow resistance Rt according to the second parameter θ2.

As shown in FIG. 1, in some embodiments, the health state calculation unit 50 may be connected to the estimation unit 40, and the health state calculation unit 50 may obtain the health state HS of the film according to the diffusion rate Dj and the flow resistance Rt. In some embodiments, the health state calculation unit 50 may store the health state equation, and the health state calculation unit 50 may obtain the health state HS of the film based on the health state equation and according to the diffusion rate Dj and the flow resistance Rt. Wherein, the health state equation is an equation related to the diffusion rate Dj and the flow resistance Rt.

As shown in FIG. 1, in some embodiments, the adaptive algorithm unit 30 may update the flux prediction value Jt_est according to the diffusion rate Dj and the flow resistance Rt. Then, the estimation unit 40 may update the diffusion rate Dj and the flow resistance Rt according to the updated flux prediction value Jt_est. Then, the health state calculation unit 50 may obtain the updated health state HS of the film based on the updated diffusion rate Dj and the updated flow resistance Rt. In some embodiments, the health state HS may be expressed as a numerical value or a percentage. Accordingly, the adaptive algorithm unit 30 and the estimation unit 40 may use the measured value each time to correct the next value. If the comparison result this time is not good, the next prediction value may be significantly corrected. On the contrary, if the comparison result this time is good, the next prediction value will only need to be slightly corrected. In other words, the adaptive algorithm unit 30 and the estimation unit 40 of the present disclosure may progressively correct the diffusion rate Dj, the flow resistance Rt, and the health state HS to achieve the effects of dynamic evaluation, dynamic correction, and/or dynamic updating of parameters.

Example embodiments of the present disclosure are described below. In the following, the term “pollutant” is used to represent solutes or suspended solids in water, but the present disclosure is not limited thereto. The term “pollutants” used herein may also refer to required recyclates, for example, valuable metals.

In some embodiments, the adaptive algorithm unit 30 may use key parameters of the film, for example, the diffusion rate Dj and the flow resistance Rt, to perform dynamic modeling. Therefore, the diffusion rate Dj and the flow resistance Rt of the film may be used as health state sensitive parameters (for example, the first parameter θ1 and the second parameter θ2) for evaluating the life of the film.

In some embodiments:

The film fouling model under transfilm pressure drop ΔP may be expressed as Equation (1):

$$\frac{dSm , j}{dt} = A \frac{Δ P}{μ Rt} ( Sr , j - Sp , j ) \qquad Equation ( 1 )$$

Wherein, Sm,j represents the film value of the j^{th} pollutant, Sp,j represents the permeate value of the j^{th} pollutant, Sr,j represents the retentate value of the j^{th} pollutant, t represents time, A represents the film area, ΔP represents the pressure drop across the film, μ represents the viscosity of water, and Rt represents the total flow resistance of the film at time t. Wherein, j is a positive integer from 1 to N.
Before any fouling occurs, the initial resistance of the film may be expressed as R0. The film fouling model may be further expressed as Equations (2)-(4).

$$Rt = R 0 + {\sum }_{j}^{N} β j \times Sm , j + γ \qquad Equation ( 2 )$$

$$Dj ( Sr , j - Sm , j ) = \frac{Δ P}{μ Rt} ( Sr , j - Sp , j ) \qquad Equation ( 3 )$$

$$Jt = \frac{Δ P}{μ Rt} \qquad Equation ( 4 )$$

Wherein, βj and γ represent the parameters of the fouling model, Dj represents the effective diffusion rate of the j^{th} pollutant, and Jt represents the flux observation value of the permeate at time t.
Equation (5) may be obtained from Equation (3).

$$Sm , j = - \frac{Δ P}{μ Rt} \frac{1}{Dj} Srp , j + Sr , j \qquad Equation ( 5 )$$

Wherein, Srp,j represents Sr,j-Sp,j.
Equation (6) may be obtained from differentiating Equation (5).

$$\frac{dSm , j}{dt} = - \frac{Δ P}{μ Rt} \frac{1}{Dj} \dot{S} rp , j + \dot{S} r , j \qquad Equation ( 6 )$$

Next, assuming that Rt and Dj are slowly changing parameters, and substituting Equation (6) into Equation (1), thus Equation (7) may be obtained.

$$\dot{S} rp , j = - A \cdot Dj \cdot Srp , j + \frac{μ Rt}{Δ P} Dj \cdot \dot{S} r , j \qquad Equation ( 7 )$$

Equation (7) is further expressed as equation (8).

$$\dot{X} j = - θ 1 , j \cdot Xj + θ2 , j \cdot Yj \qquad Equation ( 8 )$$

Wherein, Xj=Srp, j, θ1, j=A·Dj; and

$$Yj = \dot{S} r , j ,$$

$$θ2 , j = \frac{μ Rt}{Δ P} Dj ∘$$

As shown in FIG. 1, in some embodiments, the estimation unit 40 obtains the first parameter θ1 and the second parameter θ2 based on the aforementioned control differential equation, for example, Equation (8). Next, the estimation unit 40 extracts the diffusion rate Dj from the first parameter θ1 and extracts the flow resistance Rt from the second parameter θ2.

As shown in FIG. 1, in some embodiments, the health state calculation unit 50 may include a health state equation expressed as f(Dj, Rt)=HS to obtain the health state HS of the film. In some embodiments, since fouling is mainly related to the flow resistance Rt, and water quality is mainly related to the diffusion rate Dj, in the case of assuming that the water quality is fixed, the diffusion rate Dj may be regarded as a constant value. Therefore, the health state equation may be expressed as f(Rt)=HS, so that the health state HS is only related to the flow resistance Rt. In other embodiments, the health state HS may be related only to the diffusion rate Dj in the case of assuming that no fouling is occurred. In other embodiments, the health state HS may consider both the flow resistance Rt and the diffusion rate Dj.

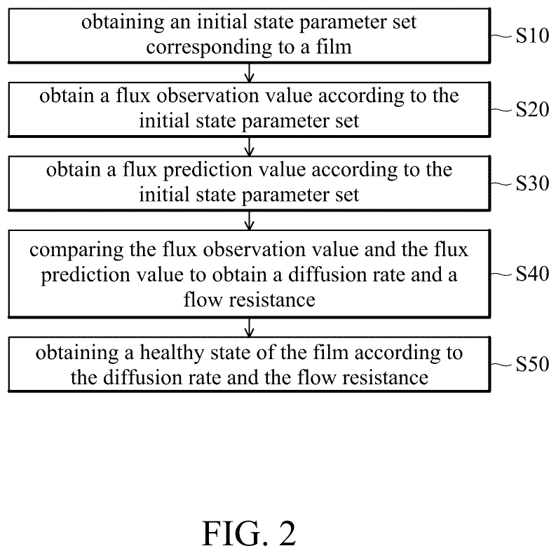

Referring to FIG. 2, it shows a schematic flowchart of a film evaluation method according to some embodiments of the present disclosure. As shown in FIG. 2, in some embodiments, in step S10, the initial state parameter sets Sp and Sr corresponding to the film may be obtained by using the measurement unit 10. In some embodiments, in step S20, the flux observation value Jt may be obtained according to the initial state parameter sets Sp and Sr by using the observation unit 20. In some embodiments, in step S30, the flux prediction value Jt_est may be obtained according to the initial state parameter sets Sp and Sr by using the adaptive algorithm unit 30. In some embodiments, in step S40, the diffusion rate Dj and the flow resistance Rt may be obtained by comparing the flux observation value Jt and the flux prediction value Jt_est by using the estimation unit 40. In some embodiments, in step S50, the health state HS of the film may be obtained according to the diffusion rate Dj and the flow resistance Rt by using the health state calculation unit 50. In some embodiments, the film evaluation method may further include: updating the flux prediction value Jt_est according to the diffusion rate Dj and the flow resistance Rt by using the adaptive algorithm unit 30. In some embodiments, the film evaluation method may further include: updating the diffusion rate Dj and the flow resistance Rt according to the updated flux prediction value Jt_est by using the estimation unit 40.

Referring to FIG. 3, it shows a schematic diagram of the diffusion rate, the flow resistance, and the health state versus the time according to some embodiments of the present disclosure. Wherein, the vertical axes of the diffusion rate Dj, the health state HS, and the flow resistance Rt are in order from left to right. As shown in FIG. 3, in some embodiments, it is assumed that the water quality is fixed, so the diffusion rate Dj may be regarded as a constant value to facilitate observation of the relationship between the flow resistance Rt and the health state HS versus time. As shown in FIG. 3, as time increases, film fouling caused by contaminants, for example, particles, microorganisms, and organic compounds will increase. Therefore, the flow resistance Rt of the film will increase, thereby reducing the filtration efficiency. Then, the increase in the flow resistance Rt of the film will lead to a decrease in the health state HS. In other embodiments, it is assumed that the water quality is not fixed, the diffusion rate Dj may be a variable value. For example, higher operating pressures may cause the fouling distribution to become more uneven and/or increase the porosity of certain areas of the film, thereby increasing the diffusion rate Dj.

In the following, an example of two-stage reverse osmosis (RO) seawater desalination is used for illustration. The parameters of Comparative Example 1 are as follows: initially set at 25° C., the salinity is 3.5%, the seawater feed rate is 14,000 m³/day (589,889 kg/hour), the water recovery rate is set at 90%, the permeate flow rate is 10,721 m³/day, and the concentrated water discharge is 3,579 m³/day. The pretreatment module uses ultrafiltration (UF) film. In addition, using steady-state numerical simulation calculations, the baseline energy consumption per ton of water is roughly estimated to be 2.1 kWh/m³ for comparison with subsequent Example 1. Wherein, Comparative Example 1 does not use the film evaluation system 1 and the film evaluation method of the present disclosure, and the other conditions of Example 1 are the same as Comparative Example 1 except that the film evaluation system 1 and the film evaluation method of the present disclosure are used.

In Example 1, the present disclosure uses the above-mentioned film evaluation system and/or film evaluation method to obtain the water recovery rate and minimum energy consumption by obtaining the intersection point of the flow curve (for example, the actual flow rate passing through the film) and the theoretical limit value of thermodynamics, and may be reversed to obtain optimized operating pressure. Wherein, the lower and the better the energy consumption, the higher and the better the water recovery rate.

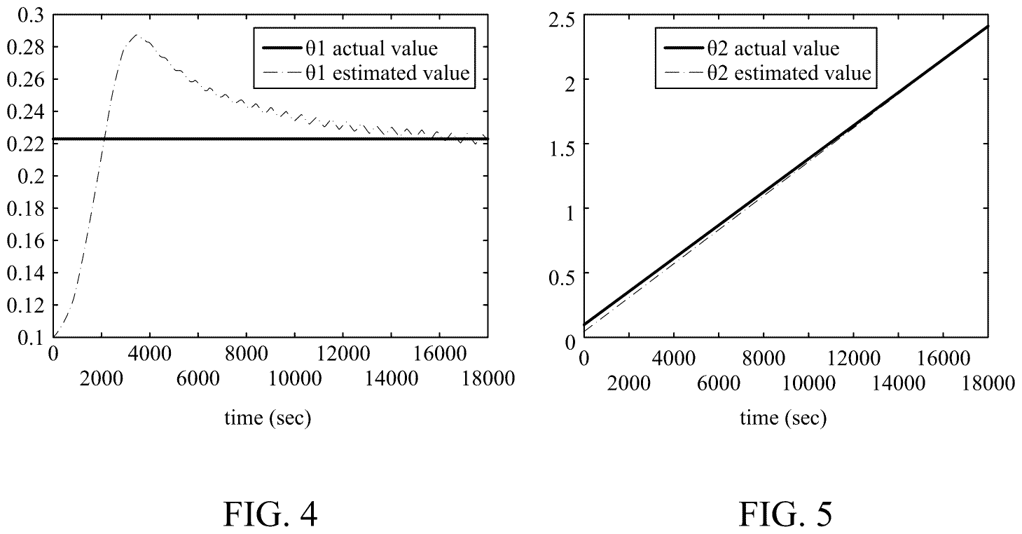

Referring to FIG. 4, it shows a schematic diagram of the first parameter θ1 versus time according to Example 1 of the present disclosure. Referring to FIG. 5, it shows a schematic diagram of the second parameter θ2 versus time according to Example 1 of the present disclosure. As shown in FIG. 4, the estimated value of the first parameter θ1 gradually approaches the actual value of the first parameter θ1. As shown in FIG. 5, the estimated value of the second parameter θ2 approximates the actual value of the second parameter θ2. In other words, in Example 1, under time t, the diffusion rate Dj and the flow resistance Rt may be accurately calculated, so that the first parameter θ1 and the second parameter θ2 that approximate actual values may be obtained.

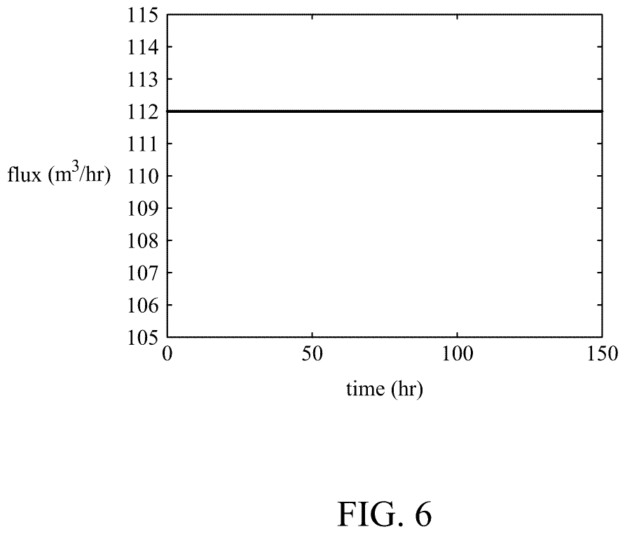

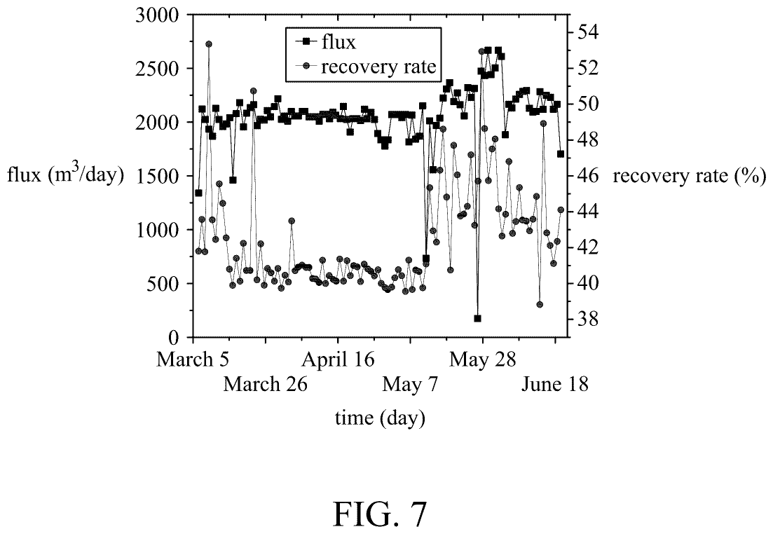

Referring to FIG. 6, it shows a schematic diagram of the flux versus the time according to Example 1 of the present disclosure. Referring to FIG. 7, it shows a schematic diagram of the flux and the water recovery rate versus the time according to Comparative Example 1 of the present disclosure. Wherein, in FIG. 7, the vertical axes of the flux and the water recovery rate are the left vertical axis and the right vertical axis in order. The dates shown in FIG. 7 are March to June 2024.

As shown in FIG. 6, the flux in Example 1 is a constant value, so the permeate flow rate may be stably maintained. The present disclosure may use a programmable logic controller (PLC) to perform automatic control. Therefore, in Example 1, the operating pressure may be adjusted according to the conditions of the film and the water quality to maintain a stable permeate flow rate. When the operating pressure increases, backwash may be performed to reduce the operating pressure. As shown in FIG. 7, in Comparative Example 1, since the operating pressure cannot be adjusted immediately, when the operating pressure is set to a fixed value, the permeate flow rate and water recovery rate fluctuate drastically. The reason for this is that, in order to avoid not achieving the target permeate flow rate, the maximum operating pressure is usually set. However, using the same maximum operating pressure under different conditions of film and water quality will result in drastic changes in the permeate flow rate and the water recovery rate.

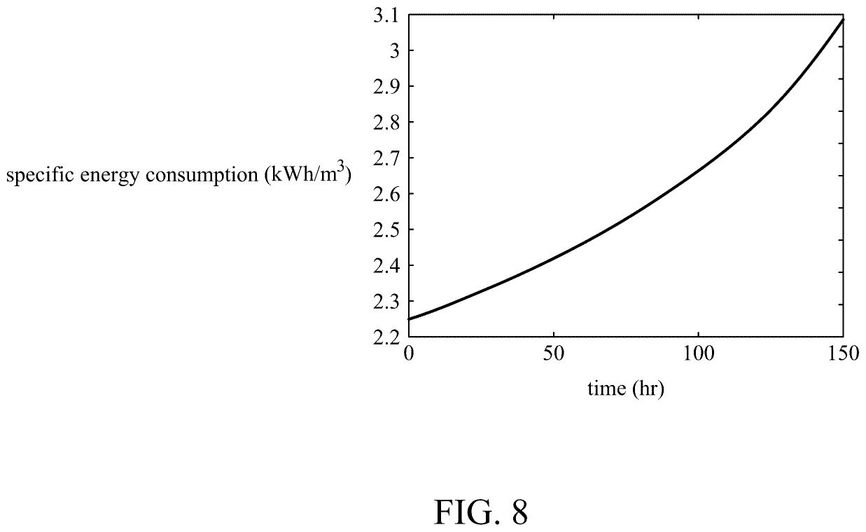

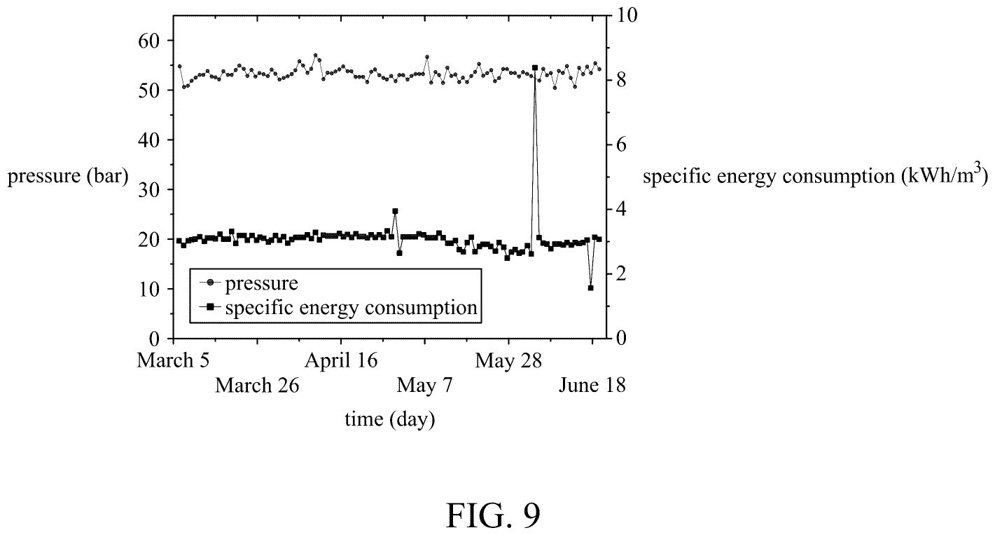

Referring to FIG. 8, it shows a schematic diagram of the specific energy consumption versus time according to Example 1 of the present disclosure. Referring to FIG. 9, it shows a schematic diagram of the specific energy consumption and the operating pressure versus time according to Comparative Example 1 of the present disclosure. Wherein, in FIG. 9, the vertical axes of the operating pressure and the specific energy consumption are the left vertical axis and the right vertical axis in order. The dates shown in FIG. 9 are March to June 2024.

As shown in FIG. 8, in Example 1, the specific energy consumption is approximately 2.25-3.1 kWh/m³. As shown in FIG. 9, in Comparative Example 1, the specific energy consumption is approximately 2.5-4 kWh/m³. Therefore, the specific energy consumption of Example 1 is lower than that of Comparative Example 1, and the energy consumption difference between the lowest specific energy consumption and the highest specific energy consumption of Example 1 is also lower than that of Comparative Example 1. Therefore, Example 1 may effectively save energy and maintain stable power consumption.

The results of Example 1 and Comparative Example 1 are as shown in Table 1.

TABLE 1

| | | Comparative |
|---|---|---|
| | Example 1 | Example 1 |
| permeate flow rate (m³/hr) | 112 | 7.2-111.2 |
| water recovery rate (%) | 50 | 40-50 |
| feed operating pressure (bar) | 26-57 | 41-54 |
| specific energy consumption (kWh/m³) | 2.27-3.1 | 2.5-4 |
| average specific energy consumption | 2.75 | 2.9 |
| (kWh/m³) | | |
| percentage of energy efficiency (%) | 16.75 | regarded as |
| | | base value |

As shown in Table 2, the permeate flow rate, the water recovery rate, the operating pressure, the specific energy consumption, and the average specific energy consumption of Example 1 of the present disclosure are all stable, and Example 1 may save energy up to 16.75%. In contrast, in Comparative Example 1, since the permeate flow rate, the water recovery rate, the operating pressure, the specific energy consumption, and the average specific energy consumption often change drastically, the overall operation of Comparative Example 1 appears unstable.

Accordingly, the present disclosure provides a film evaluation system and an evaluation method thereof to evaluate the health state of the film. For example, the measurement unit, the observation unit, the adaptive algorithm unit, the estimation unit, and the health state calculation unit are used to obtain real-time, accurate, and adaptive health state of film, and, the present disclosure uses the energy consumption optimization unit connected to the observation unit to obtain optimized parameters, for example, film operating pressure and water recovery rate to reduce energy consumption in film treatment.

In addition, by providing the film evaluation system and the film evaluation method, the present disclosure may evaluate the health state of the film in a real-time, accurate, and adaptable manner. For example, the flux observation value and the flux prediction value may be calculated based on the measured value. Then, the flux error value is calculated based on the flux observation value and the flux prediction value to obtain health state sensitive parameters (for example, the first parameter θ1 and the second parameter θ2). Then, key parameters of the film (for example, the diffusion rate Dj, the flow resistance Rt) are extracted from the first parameter θ1 and the second parameter θ2. Then, the health state of the film is evaluated based on the key parameters of the film. Therefore, the film evaluation system and the film evaluation method of the present disclosure may achieve the effects of dynamic (real-time) evaluation, dynamic correction, and/or dynamic updating of parameters without using complicated and high-cost machine learning algorithms.

Furthermore, the film evaluation system and the film evaluation method of the present disclosure may obtain optimized film-related parameters, such as optimized operating pressure. Therefore, since the applied operating pressure may be adjusted corresponding to different conditions (for example, in different films, in different water qualities, in different retentate concentrations), the energy required during the film treatment may be significantly reduced and the specific energy consumption may be reduced. Moreover, the film evaluation system and the film evaluation method of the present disclosure may also extend the life of the film, set and adjust the backwash schedule, adjust the number of cycles of water treatment, adjust the water recovery rate, and/or increase the total treated water volume (for example, permeate flow rate). Accordingly, the present disclosure provides the improved film evaluation system and the evaluation method thereof.

The foregoing outlines features of several embodiments of the present disclosure, so that a person of ordinary skill in the art may better understand the aspects of the present disclosure. A person of ordinary skill in the art should appreciate that, the present disclosure may be readily used as a basis for designing or modifying other processes and structures for carrying out the same purposes and/or achieving the same advantages of the embodiments introduced herein. A person of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A film evaluation system, comprising:
a measurement unit, wherein the measurement unit obtains an initial state parameter set corresponding to a film;
an observation unit connected to the measurement unit, wherein the observation unit obtains a flux observation value according to the initial state parameter set;
an adaptive algorithm unit connected to the observation unit, wherein the adaptive algorithm unit obtains a flux prediction value according to the initial state parameter set;
an estimation unit connected to the adaptive algorithm unit, wherein the estimation unit obtains a diffusion rate and a flow resistance by comparing the flux observation value and the flux prediction value; and
a health state calculation unit connected to the estimation unit, wherein the health state calculation unit obtains a health state of the film according to the diffusion rate and the flow resistance.

2. The film evaluation system as claimed in claim 1, wherein the adaptive algorithm unit further updates the flux prediction value based on the diffusion rate and the flow resistance, and the estimation unit further updates the diffusion rate and the flow resistance by the updated flux prediction value.

3. The film evaluation system as claimed in claim 1, wherein the adaptive algorithm unit stores a fouling model, and the adaptive algorithm unit obtains the flux prediction value based on the fouling model.

4. The film evaluation system as claimed in claim 1, wherein the estimation unit compares the flux observation value and the flux prediction value to obtain a flux error value, and the estimation unit obtains the diffusion rate and the flow resistance based on the flux error value.

5. The film evaluation system as claimed in claim 4, wherein the estimation unit further stores a control differential equation, and the estimation unit obtains a first parameter and a second parameter based on the control differential equation and according to the flux error value.

6. The film evaluation system as claimed in claim 5, wherein the estimation unit comprises a diffusion rate estimation unit and a flow resistance estimation unit, the diffusion rate estimation unit obtains the diffusion rate according to the first parameter, and the flow resistance estimation unit obtains the flow resistance according to the second parameter.

7. The film evaluation system as claimed in claim 1, wherein the health state calculation unit stores a health state equation, and the health state calculation unit obtains the health state of the film based on the health state equation and according to the diffusion rate and the flow resistance.

8. The film evaluation system as claimed in claim 1, further comprising:
an energy consumption optimization unit connected to the observation unit, wherein the energy consumption optimization unit obtains an operating pressure based on the flux observation value.

9. The film evaluation system as claimed in claim 8, wherein the energy consumption optimization unit transmits the operating pressure to the estimation unit, and the estimation unit obtains the diffusion rate and the flow resistance according to the flux observation value, the flux prediction value, and the operating pressure.

10. The film evaluation system as claimed in claim 8, wherein the energy consumption optimization unit obtains a recovery rate based on the flux observation value.

11. The film evaluation system as claimed in claim 1, wherein the initial state parameter set comprises a permeate value related to a permeate that passes through the film and a retentate value related to a retentate that does not pass through the film.

12. A film evaluation method, comprising:
obtaining an initial state parameter set corresponding to a film;
obtain a flux observation value according to the initial state parameter set;
obtain a flux prediction value according to the initial state parameter set;
comparing the flux observation value and the flux prediction value to obtain a diffusion rate and a flow resistance; and
obtaining a healthy state of the film according to the diffusion rate and the flow resistance.

13. The film evaluation method as claimed in claim 12, further comprising:
updating the flux prediction value according to the diffusion rate and the flow resistance; and
updating the diffusion rate and the flow resistance according to the updated flux prediction value.
